(19) United States
(12) Patent Application Publication
(10) Pub. No.: US 2013/0256555 A1
(43) Pub. Date: Oct. 3, 2013

(54) SHAPING OFFSET ADJUSTMENT METHOD AND CHARGED PARTICLE BEAM DRAWING APPARATUS

(71) Applicant: NUFLARE TECHNOLOGY, INC., Numazu-shi (JP)

(72) Inventor: Takahito NAKAYAMA, Yokohama-shi (JP)

(73) Assignee: NuFlare Technology, Inc., Numazu-shi (JP)

(21) Appl. No.: 13/850,626

(22) Filed: Mar. 26, 2013

(30) Foreign Application Priority Data
Mar. 29, 2012 (JP) 2012-075655

(51) Int. Cl. H01J 3/12

(52) U.S. Cl. CPC H01J 3/12
USPC 250/396 R

(57) ABSTRACT

A shaping offset adjustment method, comprising: checking a reference point formed by an overlap of first and second shaping apertures included in a charged particle beam drawing apparatus; changing a position of the first shaping aperture by deflecting a charged particle beam so that an overlap area of the first and second shaping apertures has a predetermined shot size; measuring a current value of the charged particle beam passing through the overlap area; performing fitting on a relationship between the shot size and the corresponding current value using a cubic polynomial to calculate coefficients of the cubic polynomial achieving best fit; and correcting a shaping offset amount using the calculated coefficients of the cubic polynomial.

### CROSS-REFERENCE TO THE RELATED APPLICATION

This application is based on and claims the benefit of priority from Japanese Patent Application No. 2012-075655, filed on Mar. 29, 2012; the entire contents of which are incorporated herein by reference.

### FIELD

Embodiments relate to a shaping offset adjustment method and a charged particle beam drawing apparatus.

### BACKGROUND

A lithography technique is used to form a desired circuit pattern in a semiconductor device, and a pattern transfer using an original pattern called a mask (a reticle) is performed in the lithography technique. For this technique, an electron beam drawing technique exhibiting excellent resolutions is used to manufacture a reticle with high precision.

One of methods for a charged particle beam drawing apparatus configured to perform the electron beam drawing on the reticle is a variable shaped beam method. Specifically, in the variable shaped beam method is a method in which a pattern is drawn on a workpiece placed on a movable stage by using an electron beam shaped through first and second shaping apertures.

In other words, describing in detail with reference to the accompanying drawings.

FIG. 6 is a conceptual diagram for illustrating an operation of a conventional variable-shaped electron beam drawing apparatus. A first shaping aperture 101 of a variable-shaped electron beam drawing apparatus 100 has an opening 101a formed therein for shaping an electron beam 102, and shaped in a rectangle, which is oblong, for example. Also, a second shaping aperture 103 has a variable-shaped opening 103a formed therein for shaping the electron beam 102 passing through the opening 101a of the first shaping aperture 101 into a desired rectangular shape. The electron beam 102 which is emitted from a charged particle source 104 and comes through the opening 101a of the first shaping aperture 101 is deflected by an unillustrated deflector. After that, the electron beam 102 passes through a portion of the variable-shape opening 103a of the second shaping aperture 103 and is then applied onto a workpiece 105 placed on a movable stage which successively moves in a predetermined direction.

In other words, the electron beam 102 whose shape is shaped by passing through an overlap area of the first shaping aperture 101 and the second shaping aperture 103 draws its shape onto the workpiece 105.

In this manner, in the variable-shaped beam drawing apparatus, the electron beam 102 passes through the first shaping aperture 101 and the second shaping aperture 103. Electron beams for drawing figures different in shape and size are shaped by changing how the openings of the first shaping aperture 101 and the second shaping aperture 103 overlap each other.

On the other hand, in some cases, an electron beam cannot be deflected to a predetermined calculated position because of deformations of mechanical structure such as the electron gun, lens, alignment and others, or temporal variations such as a voltage variation of an amplifier, and a slight charge-up of a structure. When such a phenomenon occurs, a shaping offset occurs and the overlap area of the first and second shaping apertures varies. For this reason, when this variation occurs, or in order to prevent this variation, the shaping offset is adjusted.

For example, the shaping offset is adjusted by gradually moving the first shaping aperture to change the overlap area with the second shaping aperture. For example, FIG. 7 shows a graph expressing a relationship between a size of the overlap area of the first and second shaping apertures and an amount of a current passing through the overlap area.

In other words, FIG. 7 is the graph which has the horizontal axis indicating a shot size as the size of the overlap area and the vertical axis indicating an amount of a current passing through the overlap area. In general, when an electron beam is normally emitted, a current amount is determined based on the overlap area of the opening of the first shaping aperture and the second shaping aperture. Accordingly, the graph of the correlation between the shot size (the overlap area) and the current amount can be expressed by an approximate linear equation passing through the origin, as shown in the graph in FIG. 7.

On the other hand, when the above-described phenomenon Occurs and an optical path of the electron beam is consequently shifted, the correlation between the shot size and the current amount is also shifted. For this reason, for example, as shown in FIG. 8, a shaping offset denoted by a sing N occurs with respect to the origin. Accordingly, the shaping offset adjustment is performed to make the shaping offset as small as possible (to make the offset point as close to the origin as possible) (see, Japanese Patent Application Publication No. H10-256110).

However, using low-degree equations, the invention disclosed in the Japanese Patent Application Publication No. H10-256110 cannot sufficiently coop with the correlation between the shot size and the current amount nor perform shaping offset adjustment with high precision, in some cases. In particular, as lines drawn as a figure pattern have become thinner and thinner with recent enhancement in fineness and density in the figure pattern, the conventional shaping offset adjustment method is considered to often fail adjustment with high precision such as a failure in cancelling out the offset.

Also, application of the linear equations used in the conventional adjustment method causes the following problem. Specifically, even if the correlation between the shot size and the current amount is normal without any shift, the application of these linear equations consequently makes a shaping offset appear as if the offset were actually present. When such a phenomenon occurs, normal adjustment to cancel out the offset ends up changing the normal state to an abnormal state.

### BRIEF DESCRIPTION OF THE DRAWINGS

FIG. 1 is a block diagram showing an entire configuration of a charged particle beam drawing apparatus according to an embodiment of the invention;

FIG. 2 is a flowchart showing a flow of adjusting a shaping offset according to the embodiment of the invention;

FIG. 3 is a schematic drawing showing a positional relationship between a first shaping aperture and a second shaping aperture at the shaping offset adjustment according to the embodiment of the invention;

FIG. 4 is a schematic drawing showing a positional relationship between the first shaping aperture and the second shaping aperture at the shaping offset adjustment according to the embodiment of the invention;

FIG. 5 is a graph showing a fitting error for each degree of a computational equation to be used when a shaping offset is adjusted;

FIG. 6 is a conceptual diagram for illustrating an operation of a conventional variable-shaped electron beam drawing apparatus;

FIG. 7 is a graph showing a relationship between a size of an overlap area of the first and second shaping apertures and an amount of a current passing through the overlap area when shaping offset adjustment is not needed; and

FIG. 8 is a graph showing a relationship between a size of an overlap area of the first and second shaping apertures and an amount of a current passing through the overlap area when shaping offset adjustment is needed.

### DETAILED DESCRIPTION

According to one embodiment, a shaping offset adjustment method comprising: checking a reference point formed by an overlap of first and second shaping apertures included in a charged particle beam drawing apparatus; changing a position of the first shaping aperture by deflecting a charged particle beam so that an overlap area of the first and second shaping apertures has a predetermined shot size; measuring a current value of the charged particle beam passing through the overlap area; performing fitting on a relationship between a shot size and a corresponding current value using a cubic polynomial to calculate coefficients of the cubic polynomial having best fit; and correcting a shaping offset amount using the calculated coefficient of the cubic polynomial.

According to another embodiment, it is preferable that the position of the first shaping aperture be changed so that the predetermined shot size gradually increases.

According to still another embodiment, it is preferable that the step of changing the position of the first shaping aperture and the step of measuring the current value of the charged particle beam passing through the overlap area of the first and second shaping apertures be repeated until a required number of current values for adjusting a shaping offset is obtained.

According to yet another embodiment, it is preferable that the shaping offset adjustment method be executed before a drawing process.

According to yet another embodiment, it is preferable that the shaping offset adjustment method be executed either at predetermined correction intervals or when a particular event occurs during the drawing process.

According to one embodiment, a charged particle beam drawing apparatus comprises a drawing unit configured to draw a pattern on a workpiece placed on a movable stage by deflecting a charged particle beam by a deflector; and a controller including a deflection controller configured to control deflection of the charged particle beam, a detector configured to measure a current value of the charged particle beam by using a Faraday cup provided on the stage, and a control calculator configured to control the deflection controller and the stage controller, wherein the control calculator includes a determination unit configured to receive information on the current value from the detector and to determine how many times the charged particle beam is already shot, and an operation unit configured to calculate coefficients of a cubic polynomial by applying a relationship between a size of the overlap area of the first and second shaping apertures and the current value into the cubic polynomial.

In the charged particle beam drawing apparatus according to still another embodiment, it is preferable that the deflection controller include a correction unit configured to perform correction to make a shaping offset amount adequate by using the coefficients of the cubic polynomial obtained by the operation unit, and that the charged particle beam be deflected based on the shot data corrected by the correction unit using the coefficients of the cubic polynomial.

According to yet another embodiment, it is preferable that the deflection controller controls the changing of the position of the first shaping aperture so that an overlap area of the first and second shaping aperture gradually increases.

Embodiment will be described hereinafter with reference to the accompanying drawings.

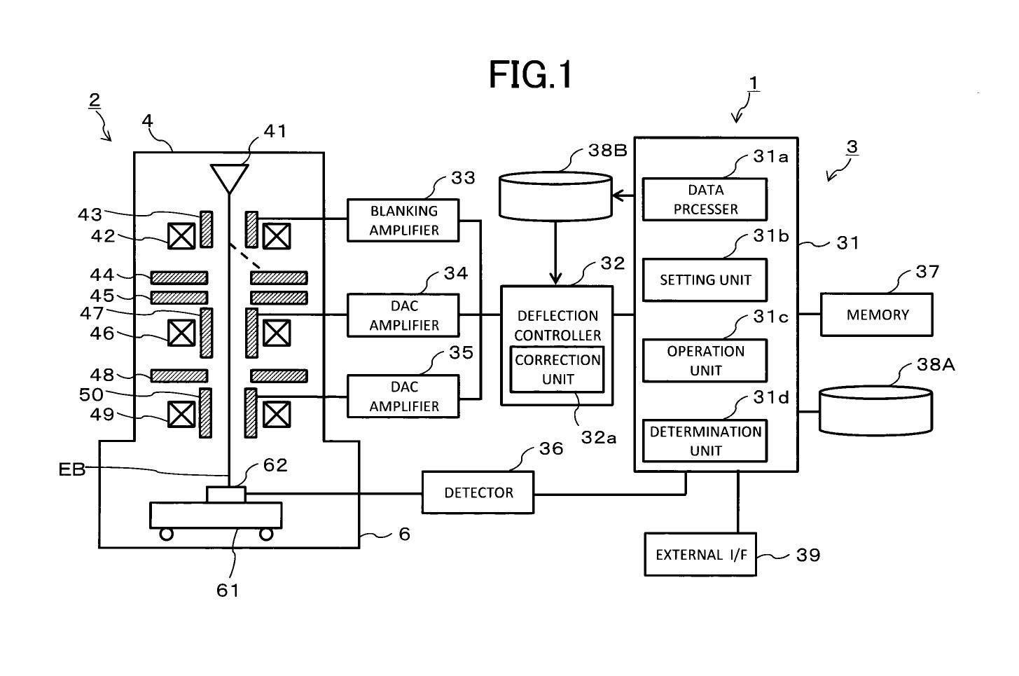

FIG. 1 is a block diagram showing an overall configuration of a charged particle beam drawing apparatus 1 in embodiments of the present invention. In the following embodiments, a configuration using an electron beam taken as an example of a charged particle beam will be described. The charged particle beam is not limited to the electron beam, and may be another beam using charged particles, such as an ion beam.

The charged particle beam drawing apparatus 1 is an apparatus configured to draw a certain Figure pattern on a workpiece, and is particularly an example of a variable-shape drawing apparatus. As shown in FIG. 1, the charged particle beam drawing apparatus 1 mainly includes a drawing unit 2 and a controller 3. The drawing unit 2 includes an electron lens barrel 4 and a drawing chamber 6.

An electron gun 41, and there are arranged in this order along an optical path of an electron beam EB emitted from the electron gun 41, an illuminating lens 42, a blanking deflector 43, a blanking aperture 44, a first shaping aperture 45, a projection lens 46, a shaping deflector 47, a second shaping aperture 48, an objective lens 49, and position deflectors 50 are arranged in the electron lens barrel 4.

In the drawing chamber 6, a XY stage 61 is arranged. A workpiece such as a mask, although not illustrated herein, on which a pattern is drawn is placed on the XY stage 61 during the drawing. On the XY stage 61, a Faraday cup 62 is arranged in a position different from the position where the workpiece is placed. The Faraday cup 62 is an apparatus configured to capture electric charges of the charged particle beam (the electron beam EB) passing through the first shaping aperture 45 and the second shaping aperture 48 and to measure a current corresponding to the number of the charged particles entering the Faraday cup 62.

The blanking deflector 43 includes multiple, for example, two or four electrodes. The shaping deflector 47, and the position deflector 50 each include multiple, for example, four or eight electrodes. Although FIG. 1 shows that only one DAC amplifier is connected to each of the shaping deflector 47, and the position deflector 50, but at least one DAC amplifier is connected to each electrode thereof. Incidentally, “DAC” of the DAC amplifier stands for “Digital to Analog Converter.”

The controller 3 includes a control calculator 31, a deflection controller 32, a blanking amplifier 33, deflection amplifiers (DAC amplifiers) 34, 35, a detector 36, a memory 37, storage units 38A, 38B such as a magnetic disk unit, and an external interface (an I/F) circuit 39 connecting the charged particle beam drawing apparatus 1 to an outside thereof.

The control calculator 31, the deflection controller 32, the detector 36, the memory 37, the storage units 38A, 38B, and the external I/F circuit 39 are connected to one another via unillustrated buses. Also, the deflection controller 32, the blanking amplifier 34, the DAC amplifiers 34, 35 are connected to one another via unillustrated buses.

A data processor 31a, a setting unit 31b, an operation unit 31c, and a determination unit 31d are provided in the control calculator 31.

The data processor 31a, the setting unit 31b, the operation unit 31c, and the determination unit 31d may be configured by software such as programs or may be configured by hardware. They may be configured by a combination of software and hardware. When each of the data processor 31a, the setting unit 31b, the operation unit 31c, and the determination unit 31d is configured by software as described above, an input data inputted to the control calculator 31 or an operation result is stored in the memory 37 every time.

Based on shot data stored in the storage unit 38B, the shot data being created by the control calculator 31, the deflection controller 32 transmits a deflection signal to the blanking amplifier 33 and the DAC amplifiers 34, 35 to control the deflection of the electron beam EB. In the present embodiment, a correction unit 32a is provided in the deflection controller 32. For example, when a shaping offset occurs in the electron beam BE passing through the first shaping aperture 45 and the second shaping aperture 48 by a position change of the electron gun 41, for example, information on the offset is transmitted to the control calculator 31 via the Faraday cup 62 and the detector 36. Based on the above information, values for correcting the offset are obtained according to a shaping offset adjustment method to be described later. The correction unit 32a receives the values for correction from the operation unit 31c and uses the received values to correct the shot data as a base data for the drawing process.

The blanking amplifier 33 is connected to the blanking deflector 43. The DAC amplifier 34 is connected to a shaping deflector 47. The DAC amplifier 35 is connected to the position deflector 50. The deflection controller 32 outputs independent digital control signals to the blanking amplifier 33 and the DAC amplifiers 34, 35, respectively. Each of the blanking amplifier 33 and the DAC amplifiers 34, receiving the corresponding digital signal converts the digital signal into an analog voltage signal, amplifies the analog signal, and outputs the analog signal as a deflection voltage to the corresponding connected deflector. In this manner, each of the deflectors receives the deflection voltage applied from the corresponding connected DAC amplifier. The deflection voltage causes deflection of the optical path of the electron beam EB.

Here, in the charged particle beam drawing apparatus 1, the shaping deflector 47 and the position deflector 50 each having four or eight electrodes are arranged in such a manner as to surround the electron beam as described above. The electrodes are paired (two pairs in the case of the four electrodes or four pairs in the case of the eight electrodes), and each pair is arranged across the electron beam. The DAC amplifiers are connected to each of the shaping deflector 47 and the position deflector 50. However, FIG. 1 shows only one DAC amplifier connected to a corresponding one of the shaping deflector 47 and the position deflector 50 and does not show the other DAC amplifiers.

The detector 36 is an ammeter, for example, which is configured to detect an amount of a current corresponding to the number of the charged particles captured by the Faraday cup 62. The detector 36 is connected to the Faraday cup 62 and the control calculator 31 and transmits the information on the current amount (the current value) of the electron beam EB to the control calculator 31.

For example, drawing data to be layout data is inputted from an outside of the charged particle beam drawing apparatus 1 and is stored in the storage unit 38A. When drawing is performed on the workpiece, the data processor 31a reads out the drawing data from the storage unit 38A and generates shot data after multiple stages of data conversion process. The generated shot data is stored in the storage unit 38B and is used when the deflection controller 32 performs the drawing process. Note that the storage units 38A, 38B are separately described for each stored data, but they can be denoted as one storage unit.

Here, FIG. 1 shows the charged particle beam drawing apparatus 1 in the embodiment of the present invention having the configuration only required to explain the embodiment of the present invention. Although one-stage deflector is used for deflecting the position of the electron beam EB, the embodiment is not limited to the above case. For example, a multi-stage deflector of two stages of a main deflector and a sub-deflector may be used to deflect the position.

The charged particle beam drawing apparatus 1 operates in the following manner to perform drawing on a target. In a case where the blanking deflector 43 sets ON the electron beam EB which is emitted from the electron gun 41 (an emission unit) and passes through the blanking deflector 43, the electron beam EB is controlled to pass through the blanking aperture 44. On the other hand, when the blanking deflector 43 sets OFF the electron beam EB, the entire electron beam EB is deflected to be blocked by the blanking aperture 44 (as shown broken line in FIG. 1). One shot of the electron beam EB is generated by the passing of the electron beam EB through the blanking aperture 44 in a period during which a deflection voltage from the blanking amplifier 33 is switched from OFF to ON and later ON to OFF.

The blanking amplifier 33 outputs the deflection voltage which alternately creates the state in which the electron beam EB passes through the blanking aperture 44 and the state in which the electron beam EB is blocked by the blanking aperture 44. Then, the blanking deflector 43 controls the direction of the passing electron beam EB based on the deflection voltage outputted from the blanking amplifier 33 and thereby alternately creates the state in which the electron beam EB passes through the blanking aperture 44 and the state in which the electron beam EB is blocked by the blanking aperture 44.

As described above, the electron beam EB is generated by passing through the blanking deflector 43 and the blanking aperture 44, and the illuminating lens 42 causes each shot of the electron beam EB to illuminate the entire first shaping aperture 45 having an aperture of a square which is an oblong, for example. Here, the electron beam EB is firstly shaped into the rectangle which is the oblong, for example. Then, the electron beam EB passing through the first shaping aperture 45 with a first aperture image is projected onto the second shaping aperture 48 by the projection lens 46. A deflection voltage for controlling the direction of the electron beam EB passing through the first shaping aperture 45 is applied to the shaping deflector 47 by the DAC amplifier 34. This makes it possible to deflect and control the first aperture image on the second shaping aperture 48 and thus to change the beam shape and dimensions.

Deflection voltages for controlling an irradiation position of the electron beam EB passing through the second shaping aperture 48 is outputted to the position deflector 50 by the DAC amplifier 35. The electron beam EB passing through the second shaping aperture 48 with a second aperture image is focused by the objective lens 49, and is emitted onto a desired position on the workpiece placed on the XY stage 61 controlled for successive moving.

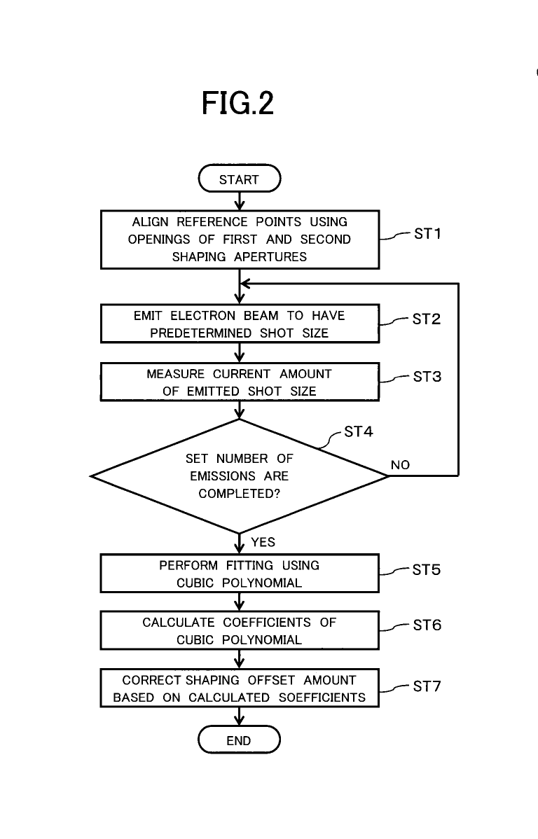

FIG. 2 is a flowchart showing a flow of adjusting a shaping offset according to the embodiment of the invention. For example, the shaping offset adjustment is performed before the start of a drawing process or also during the drawing process. Also, the frequency of performing the shaping offset adjustment during the drawing process can be set in advance: for example, at regular intervals of a certain time period; at an interval pattern in which adjustment intervals are set to gradually increase; or after a particular process in the drawing process is completed.

Firstly, points of the first shaping aperture 45 and the second shaping aperture 48, which are used as references (reference points), are aligned with each other (ST1). Here, the reference point means a contact point between one point in the opening 45a of the first shaping aperture 45 and one point in the opening 48a of the second shaping aperture 48.

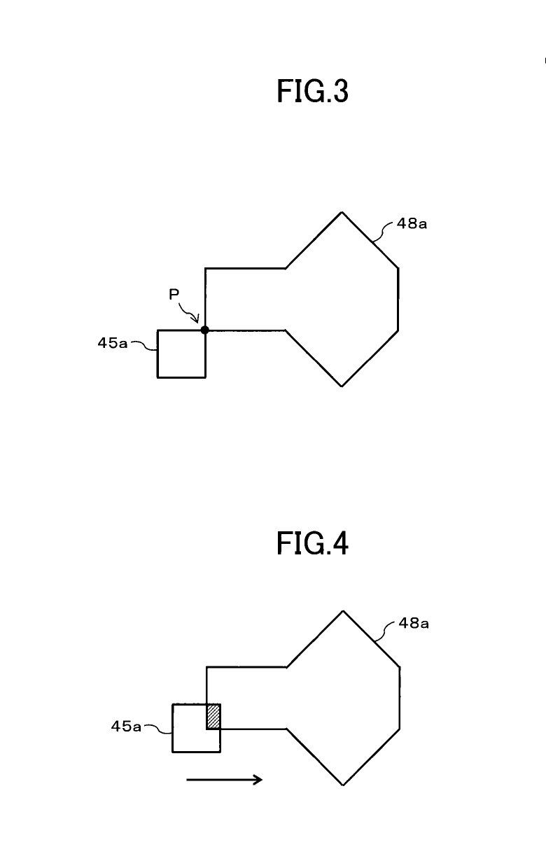

FIGS. 3 and 4 are schematic drawings, each showing a positional relationship between the first shaping aperture and the second forming aperture in the shaping offset adjustment according to the embodiment of the invention. The opening 45a of the first shaping aperture 45 has a rectangular shape, for example. Accordingly, the electron beam EB passing through this first shaping aperture 45 is shaped into a rectangle.

On the other hand, as shown in FIGS. 3 and 4, the opening 48a of the second shaping aperture 48 has a shape in which an oblong is in contact with a side a hexagonal shape with two corners at 90 degrees and four corners at 135 degrees, the side being one having the corners of 135 degrees at both ends thereof in the hexagonal shape. An opening through which the electron beam EB passes is formed in such a manner that this opening 48a and the opening 45a of the first shaping aperture 45 are combined to form an opening overlap area as needed.

In other words, the overlap area of the opening 45a and the opening 48a is a shot size in the drawing of a figure pattern on the workpiece.

Also, the opening 45a and the opening 48a can be combined to form a figure pattern, such as an oblong or triangle. In the present embodiment of the invention, as shown in FIGS. 3 and 4, a reference point P is made by matching the upper-right angle of the opening 45a with the lower-left angle of the oblong connected with the hexagon. However, the reference point may be set by using any angle of the opening 45a and the opening 48a. Multiple reference points may be also provided so that an intersection point between the opening 45a and the opening 48a is used as a reference point in a state where the overlap area of the opening 45a and the opening 48a is created.

This reference point P is a reference point set for adjusting a shaping offset. In this state, as shown in FIG. 3, there is no overlap area of the opening 45a and the opening 48a. Accordingly, the shot size is zero. The shaping offset adjustment process starts from the state in which the shot side is zero, and determines whether a shaping offset occurs in the process of increasing the shot size, and corrects the shot data in consideration of an offset when the offset is observed.

To this end, the electron beam EB is emitted to have a predetermined shot size set in advance (ST2). FIG. 4 shows that the irradiation of the electron beam EB is started and the opening 45a of the first shaping aperture 45 and the opening 48a of the second shaping aperture 48 overlap each other. The overlap area of the both openings is shown by an obliquely-hatching section in FIG. 4. This overlap area is a shot size as described above. While the electron beam EB is being emitted, the shot size is changed in such a manner that the electron beam coming through the opening 45a of the first shaping aperture 45 is gradually moved by the shaping deflector 47 in a direction shown by an arrow in FIG. 4 from the reference point P, for example.

As for the emitted electron beam EB, the number of the charged particles is figured out by the Faraday cup 62. The emitted electron beam EB is measured by the detector 36 as a current amount (ST3), and is inputted to the control calculator 31. The measured current amount is associated with the information on the shot size and is temporarily stored in the memory 37, for example. Also, every time the current amount is received, the determination unit 31d, for example, counts the reception, and determines whether a predetermined number of emissions of the electron beam EB are completed (ST4).

The emission of the electron beam EB is based on basic information (the current amount, the shot size) for the shaping offset adjustment, and thus is performed a number of times required for the adjustment. Accordingly, the number of emissions can be set as needed. The emission of the electron beam EB and the measurement of the current amount are repeated until the set number of emissions of the electron beam EB are completed.

When the set number of emissions of the electron beam EB are completed (the required number of pieces of information are collected) (YES in ST4), the operation unit 31c performs fitting using the following cubic polynomial (ST5). Here, the “fitting” means that a relationship between the shot size and the current amount is approximated using the following cubic polynomial:

y=ax³+bx²+cx+d (1)

In past cases, an error caused by the approximation (the fitting) merely using a linear equation fell within an acceptable range. However, with enhancement in fineness and density in a figure pattern, such an error cannot be ignored anymore and an adjustment with higher precision is demanded. Hence, since the fitting using the linear equation cannot provide sufficient adjustment, the cubic polynomial is used.

For example, if an optical path of the electron beam EB is shifted by a positional displacement of the electron gun 41, the current distribution of the electron beam EB passing through the first shaping aperture 45 shows an abnormal state. In general, the current distribution shows distribution similar to a contour map. In the abnormal state, the center of the distribution is offset or contour lines increase in density with narrower intervals, for example; in short, the current distribution can be said to be in a deteriorated state as compared with the normal state. Moreover, when the current distribution is deteriorated and gradually shows an abnormal state, the shaping offset adjustment may encounter a problem that the current distribution is shown in the abnormal state even though actually being in the normal state. For this reason, an influence of the current distribution has to be excluded in the shaping offset adjustment

Also, it is known that the current distribution in the first shaping aperture 45 substantially follows the Gaussian distribution. The Gaussian distribution itself can be approximated by using a quadratic polynomial. Further, the current distribution in the first shaping aperture 45 is integrated by a shot size in the shaping offset adjustment, and therefore can be expressed as a cubic component.

Accordingly, the fitting is performed using the cubic polynomial in the shaping offset adjustment, so that the influence of the current distribution in the first shaping aperture 45 can be sufficiently excluded. Thus, an error occurring in the shaping offset adjustment can be further decreased.

Moreover, in addition to the above-described advantage attributed to use of the cubic polynomial, there is another advantage as follows. For example, any one or both of the first shaping aperture 45 and the second shaping aperture 48 rotate, and are put out of phase with each other. Further, a rotation error of the shaping deflection sensitivity may occur. However, these phenomena can be each expressed as a quadratic component for the fitting. Accordingly, the usage of the cubic polynomial for the fitting is considered capable of excluding these influences.

Note that the present embodiment of the invention does not use a special cubic polynomial but uses a general equation called a cubic polynomial as equation (1).

As described above, in the present embodiment of the invention, the fitting is performed on a relationship between the shot size and the current amount by using the cubic polynomial, so that various phenomena having influences in the shaping offset adjustment can be excluded (ignored).

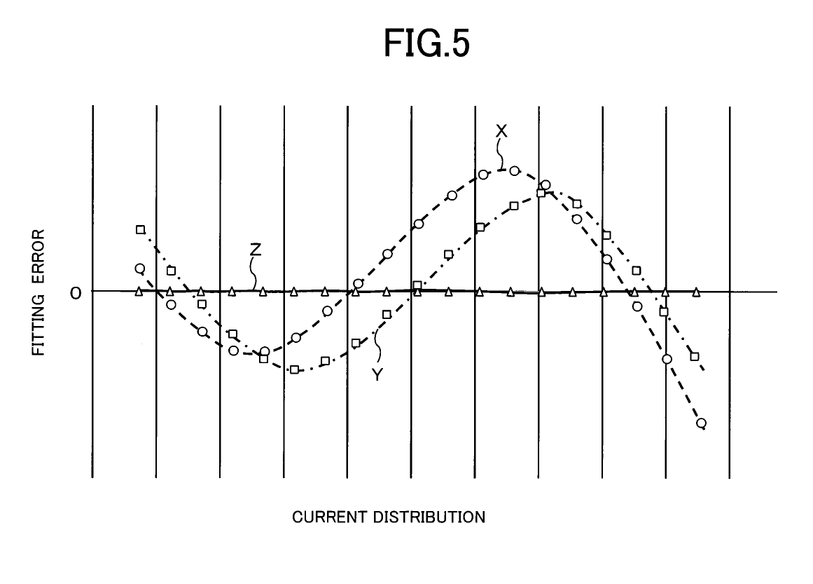

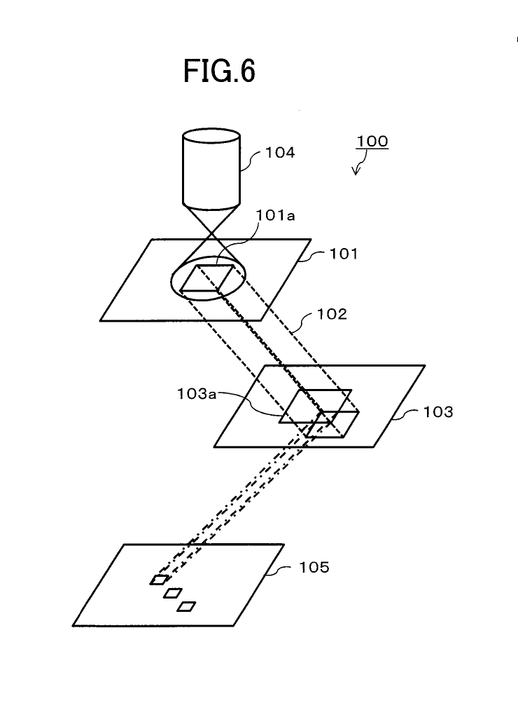

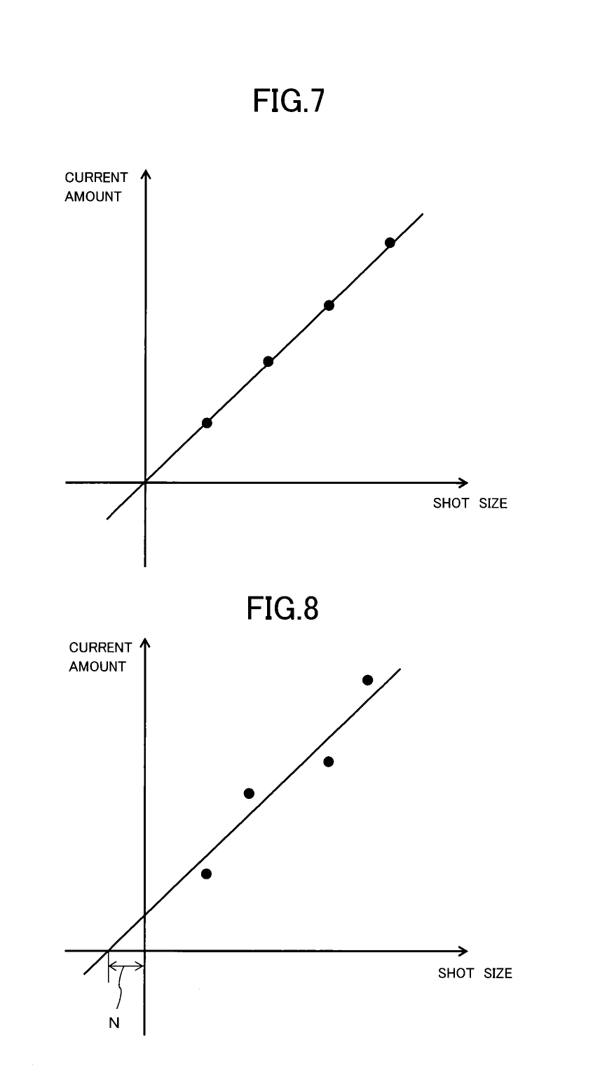

FIG. 5 is a graph showing a fitting error for each degree in a computational equation to be used in shaping offset adjustment in the present embodiment of the invention. In the graph in FIG. 5, a horizontal axis indicates the current distribution in the first shaping aperture 45 and a vertical axis indicates a fitting error state by a plus or minus using the “zero” as a reference. Accordingly, a state near zero means that there is no fitting error, and a plus or minus state means that an error occurs due to insufficient fitting.

Here, a curve X1 shown by the broken line indicates a fitting error by use of the linear equation, and a curve Y shown by the dashed line indicates a fitting error by use of a quadratic equation. Also, a solid line Z shown as substantially zero around the zero indicates a fitting error by use of the cubic equation.

According to the graph, in either of the cases where the linear equation is used and where the quadric equation is used, a fitting error frequently occurs without converging to zero. In contrast, in the case where the cubic polynomial is used, almost no fitting error occurs. Accordingly, from this graph, the approximation using the cubic polynomial can be determined as more adequate in the shaping offset adjustment.

The operation unit 31c calculates coefficients of the cubic polynomial obtained by performing the fitting (ST6). For example, assuming that a value of the shot size is set “x” and a value of the current amount is set “y”, the coefficients a, b, c, and d are obtained by using a least-squares method. As an equation for the least-squares method, the following equation is used, for example:

$$( \begin{matrix}{a}_{1} \\ {a}_{2} \\ {a}_{3} \\ {a}_{4}\end{matrix} ) = {( \begin{matrix}n & {\sum }_{i = 1}^{n} {x}_{i} & {\sum }_{i = 1}^{n} {x}_{i}^{2} & {\sum }_{i = 1}^{n} {x}_{i}^{3} \\ {\sum }_{i = 1}^{n} {x}_{i} & {\sum }_{i = 1}^{n} {x}_{i}^{2} & {\sum }_{i = 1}^{n} {x}_{i}^{3} & {\sum }_{i = 1}^{n} {x}_{i}^{4} \\ {\sum }_{i = 1}^{n} {x}_{i}^{2} & {\sum }_{i = 1}^{n} {x}_{i}^{3} & {\sum }_{i = 1}^{n} {x}_{i}^{4} & {\sum }_{i = 1}^{n} {x}_{i}^{5} \\ {\sum }_{i = 1}^{n} {x}_{i}^{3} & {\sum }_{i = 1}^{n} {x}_{i}^{4} & {\sum }_{i = 1}^{n} {x}_{i}^{5} & {\sum }_{i = 1}^{n} {x}_{i}^{6}\end{matrix} )}^{- 1} ( \begin{matrix}{\sum }_{i = 1}^{n} {y}_{i} \\ {\sum }_{i = 1}^{n} ( {x}_{i} {y}_{i} ) \\ {\sum }_{i = 1}^{n} ( {x}_{i}^{2} {y}_{i} ) \\ {\sum }_{i = 1}^{n} ( {x}_{i}^{3} {y}_{i} )\end{matrix} ) \qquad ( 2 )$$

After that, the calculated coefficients are transmitted to the correction unit 32a of the deflection controller 32. The correction unit 32a receiving the information on the correction performs correction such that an amount of the shaping offset of the shot data stored in the storage unit 32B is made as small as possible based on the calculated coefficients for execution of the drawing process (ST7). More specifically, since the adjustment of the shaping offset is performed by making the shaping offset amount as small as possible as described above, the correction is performed such that a value of representing the current amount, for example, will be 0 by using the cubic polynomial including the coefficients calculated in the operation unit 31c. Thereafter, the drawing process is performed using the shot data after correction.

As described above, in the shaping offset adjustment, shot data is corrected based on the information obtained by performing fitting using a cubic polynomial. This enables provision of a shaping offset adjustment method and a charged particle beam drawing apparatus which are capable of performing adjustment with high precision by correctly identifying a phenomenon while not needing a great change in the conventional approach.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A shaping offset adjustment method, comprising:
checking a reference point formed by an overlap of first and second shaping apertures included in a charged particle beam drawing apparatus;
changing a position of the first shaping aperture by deflecting a charged particle beam so that an overlap area of the first and second shaping apertures has a predetermined shot size;
measuring a current value of the charged particle beam with the predetermined shot size, the charged particle beam passing through the overlap area;
performing fitting on a relationship between the shot size and the corresponding current value by using a cubic polynomial to thereby calculate coefficients of the cubic polynomial achieving best fit; and
correcting a shaping offset amount using the calculated coefficients of the cubic polynomial.

2. The shaping offset adjustment method according to claim 1, wherein the position of the first shaping aperture is changed so that the predetermined shot size gradually increases.

3. The shaping offset adjustment method according to claim 1, the step of changing the position of the first shaping aperture and the step of measuring the current value of the charged particle beam passing through the overlap area of the first and second shaping apertures are repeated until a required number of current values for adjusting a shaping offset is obtained.

4. The shaping offset adjustment method according to claim 1, wherein the shaping offset adjustment method is executed before a drawing process.

5. The shaping offset adjustment method according to claim 1, wherein the shaping offset adjustment method is executed either at correction intervals determined in advance, or when a particular event occurs during a drawing process.

6. A charged particle beam drawing apparatus, comprising:
a drawing unit configured to draw a pattern on a workpiece placed on a movable stage by deflecting a charged particle beam using a deflector; and
a controller including a deflection controller configured to control deflection of the charged particle beam, a detector configured to measure a current value of the charged particle beam by using a Faraday cup provided on the stage, and a control calculator configured to control the deflection controller and the stage controller, wherein
the control calculator includes a determination unit configured to receive information on the current value from the detector and to determine how many times the charged particle beam is already shot, and
an operation unit configured to calculate coefficients of a cubic polynomial by applying a relationship between a size of the overlap area of the first and second shaping apertures and the current value to the cubic polynomial based on the information on the current value.

7. The charged particle beam drawing apparatus according to claim 6, wherein
the deflection controller includes a correction unit configured to perform correction to make a shaping offset amount adequate by using the coefficients of the cubic polynomial obtained by the operation unit, and
the charged particle beam is deflected based on the shot data corrected by the correction unit using the coefficients of the cubic polynomial.

8. The charged particle beam drawing apparatus according to claim 6, wherein the deflection controller controls the changing of the first shaping aperture so that the overlap area of the first and second shaping apertures gradually increases.
